(19) United States
(12) Patent Application Publication
(10) Pub. No.: US 2023/0111923 A1
(43) Pub. Date: Apr. 13, 2023

(54) WIRELESS HEADSET COMMUNICATION SYSTEM

(71) Applicant: STONERIDGE ELECTRONICS, AB, Solna (SE)

(72) Inventors: Darren Schumacher, Ann Arbor, MI (US); Stuart Adams, Murthly (GB)

(21) Appl. No.: 17/910,204

(22) PCT Filed: Mar. 8, 2021
(86) PCT No.: PCT/US2021/021306

§ 371 Date: Sep. 8, 2022

Related U.S. Application Data
(60) Provisional application No. 62/986,952, filed on Mar. 9, 2020.

(51) Int. Cl. B60K 35/00; H04M 1/72454

(52) U.S. Cl. CPC B60K 35/00; H04M 1/72454; B60K 2370/566; B60K 2370/186; H04M 1/6075

(57) ABSTRACT

An example system according to an example of the present disclosure includes a wireless headset having a speaker and a microphone. Control circuitry is disposed in a vehicle and is in communication with a plurality of vehicle systems. The control circuitry is configured to provide alerts through the speaker based on information from the plurality of vehicle systems indicating occurrence of trigger events, and to determine when to provide each alert based on a priority level of the alert within a multi-level hierarchy of priority levels.

### CROSS-REFERENCE TO RELATED APPLICATIONS

This application claims the benefit of U.S. Provisional Application No. 62/986,952, filed Mar. 9, 2020, the disclosure of which is incorporated by reference herein in its entirety.

### BACKGROUND

This application relates to communication with a driver of a vehicle, and more particularly to a system and method for using a wireless headset to provide alerts to a driver, to receive spoken commands from the driver, or both.

Modern vehicles provide for the availability of a large amount of information, but providing that information to drivers without distraction presents challenges.

### SUMMARY

A system according to an example of the present disclosure includes a wireless headset having a speaker and a microphone, and includes control circuitry disposed in a vehicle and in communication with a plurality of vehicle systems. The control circuitry is configured to provide alerts through the speaker based on information from the plurality of vehicle systems indicating occurrence of trigger events, and to determine when to provide each alert based on a priority level of the alert within a multi-level hierarchy of priority levels.

In a further embodiment of any of the foregoing embodiments, the control circuitry is configured to determine when to provide each alert further based on whether the wireless headset is engaged in a communication session when the alert is triggered.

In a further embodiment of any of the foregoing embodiments, the control circuitry is configured to interrupt the communication session to provide a particular alert based on the particular alert corresponding to a first priority level of the multi-level hierarchy, and postpone providing the particular alert until after the communication session is complete based on the particular alert corresponding to a second priority level that is below the first priority level in the multi-level hierarchy.

In a further embodiment of any of the foregoing embodiments, the control circuitry includes a first electronic control unit (ECU) that is part of the wireless headset and also includes a second ECU that is separate from the wireless headset and is configured to communicate with one or more of the plurality of vehicle systems over a vehicle communication bus. The first ECU is configured to perform the determining steps, interrupting step, and postponing step.

In a further embodiment of any of the foregoing embodiments, the control circuitry includes an ECU of the vehicle that is separate from the wireless headset to provide each alert; to provide each alert, the ECU transmits the alert or an identifier for the alert to the wireless headset; and the ECU is configured to perform the determining steps, interrupting step, and postponing step.

In a further embodiment of any of the foregoing embodiments, the plurality of vehicle systems include at least two of an infotainment system, an electronic logging device system, a driver information system, a vehicle monitoring system, a camera monitor system, a telematics system, and a cabin driver monitoring system.

In a further embodiment of any of the foregoing embodiments, the control circuitry is configured to obtain driver attentiveness data from one of the vehicle systems or from the wireless headset that is indicative of a level of attentiveness of a driver of the vehicle. The control circuitry is configured to compare the driver attentiveness data to predefined criteria for a non-attentive driving trigger event, and provide a non-attentive notification via the speaker based on the driver-attentiveness data meeting the predefined criteria.

In a further embodiment of any of the foregoing embodiments, the control circuitry is configured to obtain the driver attentiveness data from a motion sensor of the wireless headset, from the camera monitor system, or from a driver monitoring camera of the cabin driver monitoring system.

In a further embodiment of any of the foregoing embodiments, one of the vehicle systems is the electronic logging device system which has an electronic logging device configured to record drive time data for a driver of the vehicle indicative of an amount of driving time of the driver during a time period, and one of the trigger events corresponds to the driving time exceeding a predefined drive time threshold for the time period.

In a further embodiment of any of the foregoing embodiments, one of the vehicle systems is the vehicle monitoring system which is configured to monitor vehicle data indicative of an operational condition of the vehicle, and one of the alerts corresponds to the vehicle data crossing a predefined warning threshold.

In a further embodiment of any of the foregoing embodiments, the predefined warning threshold is a tire pressure threshold, an engine temperature threshold, or a fuel level threshold.

In a further embodiment of any of the foregoing embodiments, the control circuitry is configured to obtain data defining at least part of the multi-level hierarchy of priority levels from a fleet manager.

In a further embodiment of any of the foregoing embodiments, the control circuitry is configured to receive spoken commands from the microphone and control at least one of the vehicle systems or at least one additional vehicle system based on the spoken commands.

In a further embodiment of any of the foregoing embodiments, to control at least one of the vehicle systems based on the spoken commands, the control circuitry is configured to perform one or more of: command the camera monitor system to adjust how it provides images of an area around the vehicle or to initiate an event recording session; command the infotainment system to adjust input parameters for vehicle navigation, an HVAC system of the vehicle, or a stereo of the vehicle; command a cabin lighting system to adjust cabin lighting of the vehicle; command the vehicle telematics system to initiate a phone call; and command the electronic logging device system to authenticate a driver of the vehicle or adjust a duty status of the driver.

A method for a vehicle according to an example of the present disclosure includes utilizing control circuitry to obtain information from a plurality of vehicle systems, providing alerts through a speaker of a wireless headset in the vehicle based on the information indicating occurrence of trigger events, and determining when to provide each alert based on a priority level of the alert within a multi-level hierarchy of priority levels.

In a further embodiment of any of the foregoing embodiments, the method includes determining when to provide each alert further based on whether the wireless headset is engaged in a communication session when the alert is triggered.

In a further embodiment of any of the foregoing embodiments, the method includes interrupting the communication session to provide a particular alert based on the particular alert corresponding to a first priority level of the multi-level hierarchy, and postponing providing the particular alert until after the communication session is complete based on the particular alert corresponding to a second priority level that is below the first priority level in the multi-level hierarchy.

In a further embodiment of any of the foregoing embodiments, the control circuitry includes a first ECU that is part of the wireless headset and also has a second ECU that is separate from the wireless and is configured to communicate with at least one of the plurality of vehicle systems over a vehicle communication bus, and the first ECU performs the determining steps, interrupting step, and postponing step.

In a further embodiment of any of the foregoing embodiments, the control circuitry includes an ECU of the vehicle that is separate from the wireless headset and is configured to provide each alert the ECU transmits the alert or an identifier for the alert to the wireless headset, and the first ECU performs the determining steps, interrupting step, and postponing step.

In a further embodiment of any of the foregoing embodiments, the plurality of vehicle systems include at least two of an infotainment system, an electronic logging device system, a driver information system, a vehicle monitoring system, a camera monitor system, a telematics system, and a cabin driver monitoring system.

In a further embodiment of any of the foregoing embodiments, providing alerts includes obtaining driver attentiveness data from one of the vehicle systems or from the wireless headset indicative of a level of attentiveness of a driver of the vehicle, comparing the driver attentiveness data to predefined criteria for a non-attentive driving trigger event, and providing a non-attentive notification via the speaker based on the driver-attentiveness data meeting the predefined criteria.

In a further embodiment of any of the foregoing embodiments, the method includes he control circuitry obtaining the driver attentiveness data from a motion sensor of the wireless headset, from the camera monitor system, or from a driver monitoring camera of the cabin driver monitoring system.

In a further embodiment of any of the foregoing embodiments, the method includes recording, by an electronic logging device, drive time data for a driver of the vehicle indicative of an amount of driving time of the driver during a time period, wherein the electronic logging device is one of the vehicle systems, and wherein one of the trigger events corresponds to the driving time exceeding a predefined drive time threshold for the time period.

In a further embodiment of any of the foregoing embodiments, one of the vehicle systems is the vehicle monitoring system which is configured to monitor vehicle data indicative of an operational condition of the vehicle, and one of the alerts corresponds to the vehicle data crossing a predefined warning threshold.

In a further embodiment of any of the foregoing embodiments, the predefined warning threshold is a tire pressure threshold, an engine temperature threshold, or a fuel level threshold.

In a further embodiment of any of the foregoing embodiments, the method includes obtaining data defining at least part of the multi-level hierarchy from a fleet manager.

In a further embodiment of any of the foregoing embodiments, the method includes receiving spoken commands from a microphone of the wireless headset, and controlling at least one of the vehicle systems or at least one additional vehicle system based on the spoken commands

In a further embodiment of any of the foregoing embodiments, controlling at least one of the vehicle systems based on the spoken commands includes performing one or more of: commanding the camera monitor system to adjust how it provides images of an area around the vehicle or to initiate an event recording session; commanding the infotainment system to adjust input parameters for vehicle navigation, a HVAC system of the vehicle, or stereo of the vehicle; commanding a cabin lighting system to adjust cabin lighting of the vehicle; commanding the vehicle telematics system to initiate a phone call; and commanding the electronic logging device system to authenticate a driver of the vehicle or adjust a duty status of the driver.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 is a schematic view of a driver communication system.

FIG. 2 illustrates an example implementation of a wireless headset of FIG. 1.

FIG. 3 illustrates example camera locations for a camera monitor system.

FIG. 4 illustrates portions of example vehicle systems within a vehicle cabin.

FIG. 5 illustrates an example multi-level hierarchy of priority levels for providing alerts to a vehicle driver.

FIG. 6 is a flowchart of an example method for providing alerts to a driver.

### DETAILED DESCRIPTION

Examples in the present disclosure describe a system for providing alerts to a vehicle driver using a wireless headset. The alerts are based on a comparison of information from a plurality of vehicle systems to predefined alert criteria. A timing of the alerts can be determined based on a multi-level hierarchy of priority levels, which allows for certain alerts to be delivered more urgently than other alerts. In some embodiments the wireless headset also provides for control of one or more of the vehicle systems.

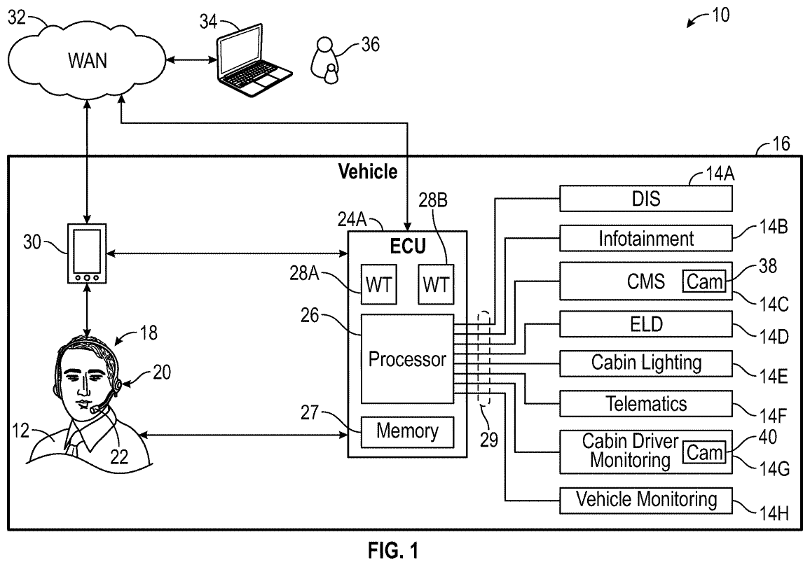

FIG. 1 is a schematic view of a driver communication system 10 that provides for communication between a driver 12 and a plurality of vehicle systems 14A-H of a vehicle 16 utilizing a wireless headset 18. The wireless headset 18 includes a speaker 20 and a microphone 22.

In the example of FIG. 1, the plurality of vehicle systems include a driver information system (DIS) 14A, an infotainment system 14B, a camera monitor system (CMS) 14C, an electronic logging device (ELD) system 14D, a cabin lighting system 14E, a telematics system 14F, a cabin driver monitoring system 14G, and a vehicle monitoring system 14H. It is to be understood that this is only a non-limiting example and that other vehicle systems 14 could be utilized, and that other quantities of vehicle systems 14 could be utilized (e.g., more or less than 8 systems).

The system 10 includes control circuitry 24 operable to communicate with the plurality of vehicle systems 14A-H, and, for at least some of the vehicle systems 14A-H, provide alerts through the speaker 20 of the wireless headset 18 based on information from the plurality of vehicle systems indicating occurrence of trigger events. In some embodiments, the control circuitry 24 is also operable to control one or more of the vehicle systems 14 based on voice commands received from the microphone 22 of the wireless headset 18.

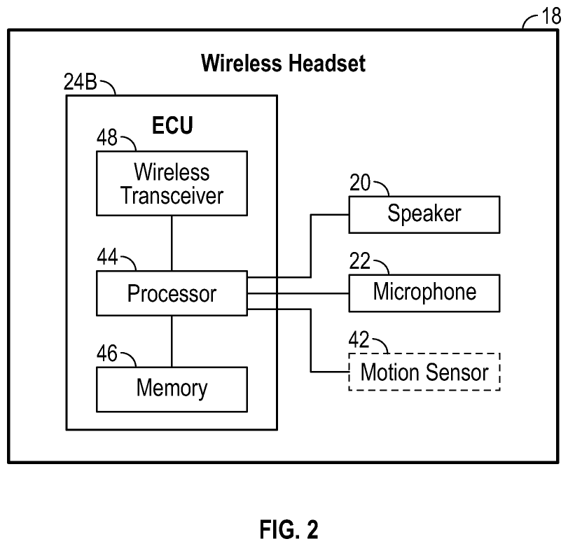

The control circuitry 24 includes an electronic control unit (ECU) 24A of the vehicle and an ECU 24B of the wireless headset 18 (shown in FIG. 2). Reference numeral 24 will be generally used herein to refer the control circuitry.

The ECU 24A includes a processor 26 operatively connected to memory 27, a first wireless transceiver 28A, and optionally also to a second wireless transceiver 28B.

The processor 26 includes one or more microprocessors, microcontrollers, application specific integrated circuits (ASICs), or the like. The memory 27 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 27 may incorporate electronic, magnetic, optical, and/or other types of storage media.

The first wireless transceiver 28A is operable to provide for wireless communication with the wireless headset 18, and may be a BLUETOOTH transceiver, for example.

The optional second wireless transceiver 28B, if included, is operable to wirelessly communicate with one or more devices outside of the vehicle 16 through a wide area network (WAN) 32 (e.g., the Internet) using a defined wireless communication standard, such as a 3GPP standard (e.g., LTE, W-CDMA, GSM, etc.) or an IEEE standard (e.g., WiMax, WiFi, etc.). Of course, it is understood that other standards could be used in addition or as an alternative to these.

The ECU 24A is operatively connected to each of the vehicle systems 14 through one or more connections 29. In one example, the connection 29 between the ECU 24A and one or more of the vehicle systems corresponds to a vehicle information bus, such as a Control Area Network (CAN) bus.

The driver 12 may optionally have a mobile phone 30 in their possession within the vehicle 16. The mobile phone 30 is operable to communicate with remote devices over the WAN 32 using, e.g., one of the communication standards listed above.

A fleet manager 36 that manages a fleet of vehicles is able to use a computing device 34 to communicate with the mobile phone 30 and/or ECU 24A over the WAN 32. This communication can be used to monitor activity of the vehicle 16 and/or the driver 12, ELD data from the ELD system 14D, and/or driver-attentiveness data from the cabin driver monitoring system 14G, for example. In one example the ELD system 14D includes the EZ-ELD product from Stoneridge, Inc. In one example, the fleet manager 36 can also monitor the data that is collected by the ECU 24A from the vehicle systems 14 (e.g., driver attentiveness data). In one example, communication from the fleet manager 36 can be used to define the multi-level hierarchy of priority levels discussed above.

The CMS 14C includes one or more cameras 38 configured to record images of an exterior environment of the vehicle 16, and the cabin driver monitoring system 14G includes one or more cameras 40 configured to record images of the driver 12 within a cabin of the vehicle 16.

FIG. 2 illustrates an example implementation of the wireless headset 18. In the example of FIG. 2 the wireless headset 18 includes an ECU 24B that is operatively connected to the speaker 20, the microphone 22, and optionally also a motion sensor 42 (e.g., an accelerometer and/or gyroscope) that is operable to measure movement of the wireless headset 18. The motion data may be used to determine if the driver 12 non-attentive (e.g., drowsy or distracted), and therefore may be considered part of the cabin driver monitoring system 14G.

The ECU 24B includes a processor 44 operatively connected to memory 46 and a wireless transceiver 48 (e.g., a BLUETOOTH transceiver). The wireless transceiver 48 is configured to communicate with the ECU 24A. The processor 44 includes one or more microprocessors, microcontrollers, application specific integrated circuits (ASICs), or the like. The memory 46 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 46 may incorporate electronic, magnetic, optical, and/or other types of storage media.

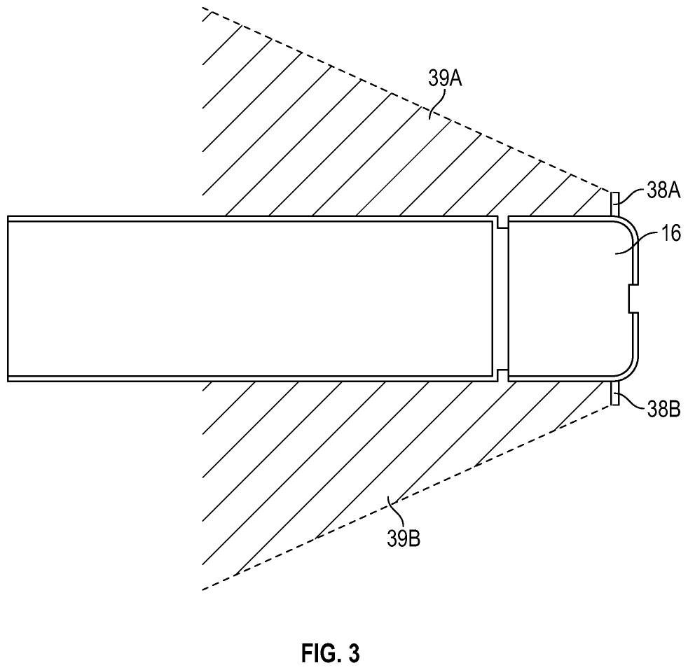

FIG. 3 illustrates an example of two cameras 38A-B of the CMS 14C. As shown in FIG. 3, the cameras 38A-B could be configured to record images of areas 39A-B outside of the vehicle 16 (e.g., a Class II and/or Class IV view). This information could be used to detect potential vehicle accidents and/or non-attentive driving (e.g., based on erratic driving/swerving).

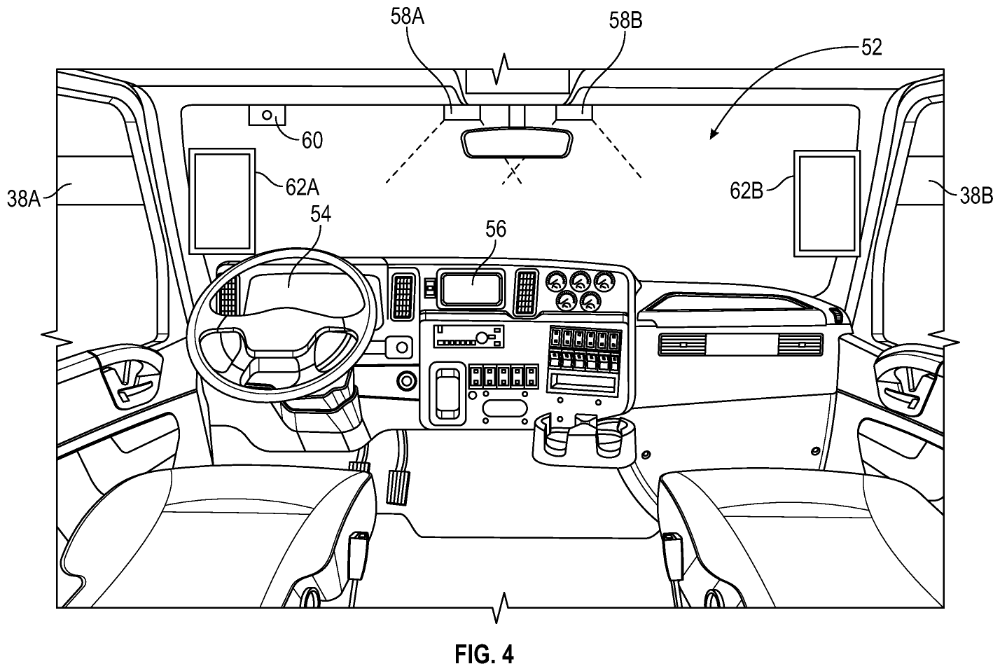

FIG. 4 illustrates an example cabin 52 of the vehicle 16 that includes an instrument cluster 54, an infotainment electronic display 56, cabin lights 58A-B, a driver monitoring camera 60, and CMS electronic displays 62A-B.

Referring now to FIGS. 4 with continued reference to FIGS. 1-2, the DIS 14A is operable to display information on the instrument cluster 54, such as speedometer information, odometer information, telltale indicators (e.g., low tire pressure, engine overheating, etc.).

The infotainment system 14B is operable to provide one or more of navigation information (e.g., turn-by-turn directions), messaging (e.g., SMS messages or email messages), music playback and/or radio station information, and the like on the infotainment electronic display 56.

The CMS 14C uses the cameras 38A-B to record images of the areas 39A-B corresponding to an exterior environment of the vehicle 16, and provides images on the CMS electronic displays 62A-B based on what is recorded by the cameras 38. In one example, the CMS 14C is the Stoneridge® MirrorEye® CMS. In one example the CMS 14C is operable to perform event recording (e.g., recording a video feed) and/or object detection outside of the vehicle 16.

The ELD system 14D includes an electronic logging device configured to record drive time data for the vehicle 16, which may be a commercial vehicle, that is indicative of an amount of driving time of the driver 12 within a time period (e.g., cumulative driving time and/or consecutive driving time). The ELD system 14D includes a tachograph in one example that also measures a distance traveled by the vehicle 16 during the time period. The ELD system 14D is operable to determine whether the driver 12 is complying with hours of service (HOS) legal requirements, such as a maximum number of cumulative and/or consecutive driving time during the time period.

The cabin lighting system 14E is configured to receive commands from the ECU 24A to control cabin lighting in a cabin of the vehicle 16, such as the cabin lights 58A-B based on the commands (e.g., based on voice commands received from microphone 22 of the wireless headset 18).

The telematics system 14F is operable to cause the mobile phone 30 to initiate phone calls, and may also be operable to retrieve SMS and/or email messages from the mobile phone 30. The telematics system 14F is also operable to detect whether the driver 12 is currently engaged in a communication session over their mobile phone 30. The ECU 24B is operable to cooperate with the telematics system 14F to obtain information (e.g., whether the driver 12 is engaged in a session) and/or to initiate phone calls based on voice commands from the driver 12 received through microphone 22. In one example, the telematics system 14F is operable to transmit and receive other information besides phone calls, such as messages to and from the vehicle 16, to and from the fleet manager 36, and/or to and from some other monitoring authority.

The cabin driver monitoring system 14G is operable to obtain driver attentiveness data that is indicative of a level of attentiveness of the driver 12 using the driver monitoring camera 60.

The ECU 24B is operable to obtain driver attentiveness data from the cabin driver monitoring system 14G (e.g., from driver monitoring camera 60 and/or motion sensor 42 of the wireless headset 18) to determine whether the driver is drowsy and/or distracted. This could include the ECU 24A receiving raw data from the system 14G and performing the detecting, or could include the cabin driver monitoring system 14G performing the detecting and the ECU 24A receiving a notification that a driver attentiveness alert is needed, for example.

The determination of whether a driver is drowsy and/or distracted is based on comparison of raw attentiveness data to predefined non-attentive driving criteria. The criteria in one example defines alerts for events such as the driver 12 exhibiting head movements indicative of the driver nodding off to sleep, looking downwards for extended periods of time (e.g., at the mobile phone 30), etc.

The vehicle monitoring system 14H includes one or more sensors operable to monitor a condition of the vehicle, such as a speed, distance traveled, engine temperature, tire pressure, etc. In one example, the telltale indicators on the DIS 14A are based on information from the vehicle monitoring system 14H.

The control circuitry 24 provide alerts through the speaker 20 of the wireless headset 18 based on information from the plurality of vehicle systems 14 indicating occurrence of trigger events, and in some embodiments determines when to provide the alerts based on a priority level of the alerts within a multi-level hierarchy of priority levels.

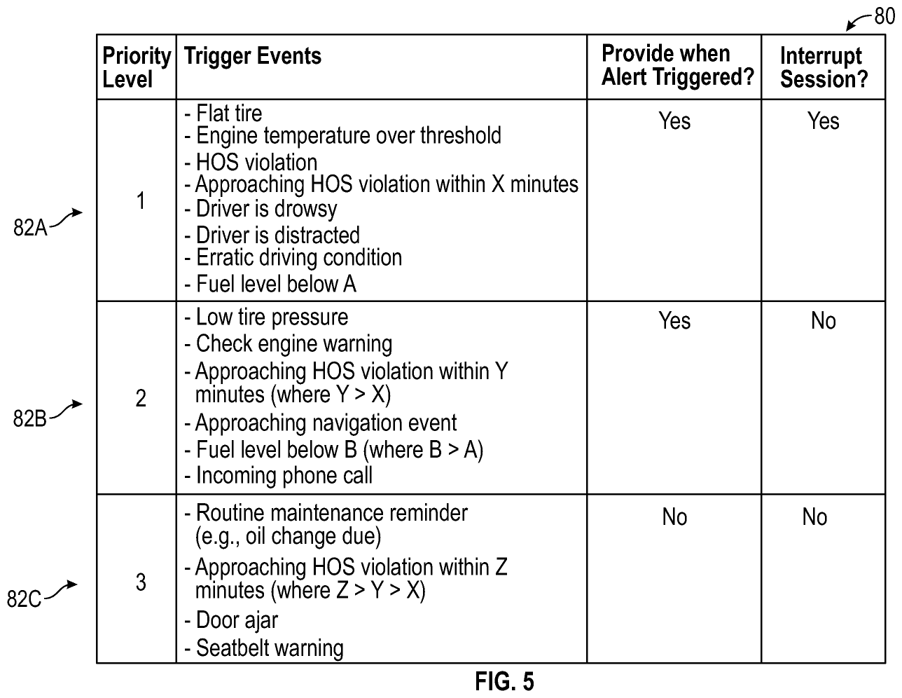

FIG. 5 illustrates an example multi-level hierarchy 80 of priority levels that includes a first level 82A, a second level 82B, and a third level 82C. Each level 82 corresponds to a degree of importance and/or urgency. A first level alert is considered urgent, is provided when the alert is triggered by its corresponding trigger event, and will interrupt a current communication session of a user if needed (e.g., interrupt a phone call through mobile device 30 or the playing of a media file from the infotainment system 14B, such as the radio or a podcast). Some example first level trigger events from FIG. 5 include the vehicle 16 having a flat tire, a temperature of an engine of the vehicle 16 being over a predefined temperature threshold, the driver 12 having violated an hours of service threshold associated with the ELD system 14D, the driver 12 being within a predefined number (“X”) minutes of an house of service violation, the driver 12 being non-attentive (e.g., drowsy or distracted), and a fuel level of the vehicle 16 is below a predefined fuel level threshold (“A”). Of course, these are non-limiting examples, and it is understood that other first level trigger events could be used. The alert that is provided for a given trigger event indicates to the driver that the trigger event has occurred (e.g., alert the driver 12 that there is a flat tire, alert the driver 12 that the engine temperature is over the predefined temperature threshold, alert the driver 12 that they have violated their house of service requirements, etc.).

A second level alert is provided when it is triggered but will not interrupt a current communication session. Thus, if the driver 12 is engaged in a phone call using the wireless headset 18 that phone call will be allowed to complete before the second level alert is provided. In one example, a second level alert is provided right after a communication session that would otherwise have been interrupted by the alert.

As shown in FIG. 5, some example second level trigger events include a tire pressure of a tire of the vehicle 16 being below a predefined tire pressure threshold, a check engine light appearing on the instrument cluster 54, the driver 12 being within a predefined number of minutes (“Y”) of an hours of service violation (where Y>X), the vehicle 16 being within a predefined distance of a navigation event (e.g., a turn), a fuel level of the vehicle 16 being below a predefined threshold (“B”, where B>A); and a phone call being received on the mobile phone 30. Here too, the alert that is provided for a given trigger event indicates to the driver that the trigger event has occurred (e.g., alert the driver 12 that tire pressure is low, that check engine light has come on, etc.).

A third level alert is provided at some future time after the alert is triggered and will not interrupt a current communication session. Some example third level alert trigger conditions include a routine maintenance reminder event (e.g., an oil change being due now or within a predefined threshold amount of miles, the driver 12 being within a predefined number of minutes (“Z”) of an hours of service violation (where Z>Y>X), a vehicle door being ajar, a seatbelt of the driver 12 not being engaged, etc. Third level alerts may be provided once a day, for example, or the next time the vehicle 16 is started or stopped. Here too, the alert that is provided for a given trigger event indicates to the driver that the trigger event has occurred (e.g., alert the driver 12 that a routine maintenance event is upcoming, that a door is ajar, that their seatbelt is not engaged, etc.).

In one example the fleet manager 36 can define their own alerts, modify existing alerts, and/or control where various alerts reside in the hierarchy 80 for its fleet of vehicles 16 and driver 12, giving the fleet manager 36 the ability to determine which alerts should be provided and how those alerts should be prioritized. This can be achieved through communications between the computing device 34 of the fleet manager 36 over the WAN 32 to the control circuitry 24 or mobile device 30, for example. Alternatively, this could be achieved through local communication when the vehicle 16 is docked at a particular location.

As discussed above, each of the alerts in the hierarchy 80 has associated predefined criteria that defines when the alert is to be triggered. For example, the “flat tire” alert of FIG. 5 could be triggered when the vehicle monitoring system 14 detects that the tire pressure of a tire of the vehicle 16 has crossed and fallen below a flat tire pressure threshold. As another example, the “engine temperature over threshold” alert of Figure could be triggered when the vehicle monitoring system 14 detects that a temperature of the engine of the vehicle 16 has crossed and exceeded a predefined temperature threshold.

As shown in FIG. 5, some alerts have counterparts in multiple levels. For example, if the fuel level of the vehicle is 16 is below B, the “fuel level below B” alert in level 82B provide a second level warning, but if the fuel level falls below A (where B>A) then the “fuel level below A” alert in level 82A is provided.

Different ones of the alerts can implicate different ones of the vehicle systems 14. For example, the fuel level, tire pressure, and/or engine temperature alerts could implicate the vehicle monitoring system 14H and/or the DIS 14A (which provides visual indications of telltales).

A plurality of example alerts are provided below:
DIS 14A providing an alert that a telltale has been activated (e.g., check engine light is on, door is ajar, seatbelt is not engaged, etc.);
infotainment system 14B providing an alert that the vehicle 16 is approaching a navigation event (e.g., a turn);
CMS 14C providing an alert that another vehicle is about to pass the vehicle 16, a warning that there is an obstruction to a potential or on-going lane change, a lane drift warning, a warning that the vehicle 16 is following another vehicle too closely, a warning that another vehicle is following the vehicle 16 more closely, etc.;
ELD system 14D providing an alert that an HOS violation has occurred or that the driver 12 is within a predefined number of miles or minutes of an HOS violation;
cabin lighting system 14E providing an alert that one or both of the cabin lights 58A-B are on during daylight hours;
telematics system 14F providing an alert that the mobile phone 30 has an incoming phone call;
cabin driver monitoring system 14G providing an alert that the driver 12 is non-attentive;
vehicle monitoring system 14H providing a warning related to tire pressure, engine temperature, fuel level, etc.

In one example, in conjunction with providing one or more particular alerts, the control circuitry 24 maintains a written log of the alerts (e.g., in memory 27) and/or transmits a notification to the fleet manager 36. In one example, the fleet manager 36 can control which alerts get logged and/or yield fleet manager notifications. Certain alerts may be of particular interest to the fleet manager 36, such as non-attentive driving alerts and/or flat tire alerts, and could be prioritized accordingly based on notification criteria controlled by the fleet manager 36.

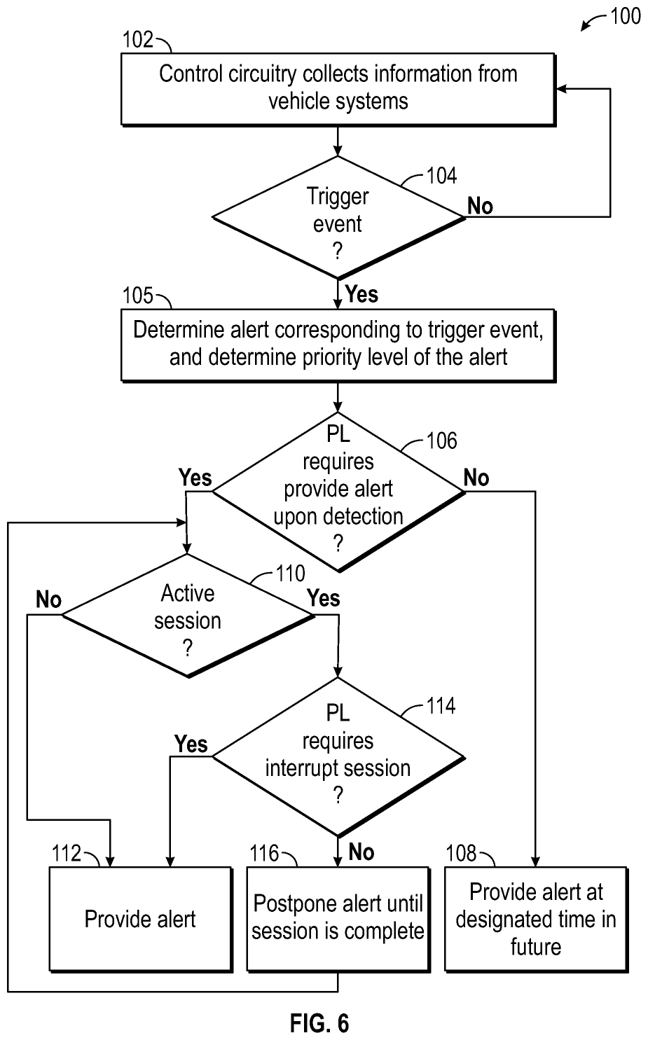

FIG. 6 is a flowchart 100 of a method for providing alerts to the driver 12. The control circuitry 24 is utilized to collect information from the vehicle systems 14 (step 102), and compare the information to predefined criteria for trigger events to determine if a trigger event has occurred (step 104). If a trigger event has not occurred (a “no” to step 104), the control circuitry 24 continues collecting the information (step 102). If a trigger event has occurred (a “yes” to step 104), the control circuitry 24 determines an alert for the trigger event and determines a priority level for the alert (step 105). As an example, the alert could be a level 1 alert (82A), level 2 alert (82B), or level 3 alert (82C) using the hierarchy of FIG. 5.

If the priority level does not require providing an alert upon detection (a “no” to step 106), the alert is provided through the speaker 20 at a designated time in the future. This could correspond to alerts from priority level three (82C) from the example of FIG. 5, for example. The “designated time in the future” could correspond to a future event, such as the next time the vehicle 16 is started, or a predefined future time, or a future time (e.g., one hour away).

If the priority level requires providing an alert upon detection (a “yes” to step 106), the control circuitry 24 determines if the driver 12 is engaged in an active session using the wireless headset 18 (step 110). This could include the driver 12 being in a phone call with the mobile device 30, the driver 12 listening to audio from the infotainment system 14B (e.g., radio, a podcast, etc.), the driver 12 providing a command over the microphone 22, or the driver 12 receiving a lower priority alert from the control circuitry 24, for example.

If there is no active session (a “no” to step 110), the control circuitry provides the alert (step 112). Otherwise, if there is an active session (a “yes” to step 110), the control circuitry determines if the priority level requires interrupting the session (step 114).

If the priority level requires interrupting a current session (a “yes” to step 114, which could correspond, e.g., to priority level 1 (82A) in FIG. 5), the control circuitry 110 interrupts the current session and provides the alert through the speaker 20 (step 112). Otherwise, if the priority level does not require interrupting a current session (a “no” to step 114) (e.g., priority level 2 (82B) in FIG. 5), the control circuitry 24 postpones the alert until the session is complete (step 116).

The performance of the method 100 can be allocated in different ways between the ECU 24A and ECU 24B. In one example, the ECU 24A lacks functionality to generate alerts, and determine when to provide the alerts (e.g., steps 106, 110, 114, 116), and therefore provides alerts when they are received from the ECU 24B. In another example, the ECU 24A performs some or all of steps 106, 110, 114, and 116 and plays an active role in determining when to provide alerts. In one such example, the ECU 24A stores a scheduled alert and provides it at an appropriate time (e.g., according to step 112 and/or 108).

In one example, the alerts are stored as audio recordings in the memory 46 of the ECU 24B, so that the ECU 24A can transmit an alert identifier to the ECU 24B and the ECU 24B can playback the alert corresponding to that identifier. In one example, the alerts are received as audio transmissions at the ECU 24B from the ECU 24A and are not stored in long term memory of the ECU 24B.

As described above, the wireless headset 18 can serve as an input device for controlling various aspects of the vehicle 16. For example, in some embodiments the control circuitry 24 is operable to control one or more of the vehicle systems 14 based on voice commands received from the microphone 22 of the wireless headset 18. Some example commands could include the following:
commanding the CMS 14C to adjust how it provides images of an area around the vehicle 16 and/or to initiate an event recording session that records and saves images from the CMS cameras 38A-B;
commanding the infotainment system 14B to adjust input parameters for vehicle navigation (e.g., destination, starting point, etc.), to adjust an HVAC system of the vehicle 16, or to adjust a vehicle stereo of the infotainment system 14B (e.g., radio tuning, skipping songs, rewind podcast, etc.);
commanding the cabin lighting system 14E to adjust cabin lighting of the vehicle 16;
commanding the telematics system 14F to initiate or a phone call using the mobile phone 30; and
commanding the ELD system to 14D authenticate the driver 12 (e.g., indicate that a particular driver 12 is now driving the vehicle 16) or adjust a duty status of the driver 12 (e.g., change status from “break” to “on duty”).

The driver communication system 10 discusses herein improves interactions of the driver 12 with the vehicle 16, and requires less effort and less distraction than existing vehicle systems. By enabling the driver 12 to focus their attention on the road and their exterior environment, the system 10 minimizes distractions to the driver 12.

Use of the microphone 22 in proximity to the mouth of the driver 12 provides a better signal to noise ratio than would be provided by a cabin-based microphone that is integrated into the vehicle 16 and is not part of the headset 18.

Although certain elements of the system 10 are described as being optional, it is understood that this does not mean that other elements not explicitly described as optional are required components. For example, a different set of vehicle systems 14 could be used than those described above even though the described systems 14 are not explicitly indicated as being optional.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A system comprising:
a wireless headset including a speaker and a microphone; and
control circuitry disposed in a vehicle and in communication with a plurality of vehicle systems, the control circuitry configured to:
provide alerts through the speaker based on information from the plurality of vehicle systems indicating occurrence of trigger events; and
determine when to provide each alert based on a priority level of the alert within a multi-level hierarchy of priority levels.

2. The system of claim 1, wherein the control circuitry is configured to determine when to provide each alert further based on whether the wireless headset is engaged in a communication session when the alert is triggered.

3. The system of claim 2, wherein the control circuitry is configured to:
interrupt the communication session to provide a particular alert based on the particular alert corresponding to a first priority level of the multi-level hierarchy; and
postpone providing the particular alert until after the communication session is complete based on the particular alert corresponding to a second priority level that is below the first priority level in the multi-level hierarchy.

4. The system of claim 1, wherein the plurality of vehicle systems include at least two of an infotainment system, an electronic logging device system, a driver information system, a vehicle monitoring system, a camera monitor system, a telematics system, and a cabin driver monitoring system.

5. The system of claim 4, wherein the control circuitry is configured to:
obtain driver attentiveness data from one of the vehicle systems or from the wireless headset that is indicative of a level of attentiveness of a driver of the vehicle;
compare the driver attentiveness data to predefined criteria for a non-attentive driving trigger event; and
provide a non-attentive notification via the speaker based on the driver-attentiveness data meeting the predefined criteria.

6. The system of claim 4, wherein:
one of the vehicle systems is the electronic logging device system which includes an electronic logging device configured to record drive time data for a driver of the vehicle indicative of an amount of driving time of the driver during a time period; and
one of the trigger events corresponds to the driving time exceeding a predefined drive time threshold for the time period.

7. The system of claim 4, wherein:
one of the vehicle systems is the vehicle monitoring system which is configured to monitor vehicle data indicative of an operational condition of the vehicle; and
one of the alerts corresponds to the vehicle data crossing a predefined warning threshold.

8. The system of claim 4, wherein:
the control circuitry is configured to receive spoken commands from the microphone and control at least one of the vehicle systems or at least one additional vehicle system based on the spoken commands; and
to control at least one of the vehicle systems based on the spoken commands, the control circuitry is configured to perform one or more of:
command the camera monitor system to adjust how it provides images of an area around the vehicle or to initiate an event recording session;
command the infotainment system to adjust input parameters for vehicle navigation, an HVAC system of the vehicle, or a stereo of the vehicle;
command a cabin lighting system to adjust cabin lighting of the vehicle;
command the vehicle telematics system to initiate a phone call; and
command the electronic logging device system to authenticate a driver of the vehicle or adjust a duty status of the driver.

9. A method for a vehicle comprising:
utilizing control circuitry to obtain information from a plurality of vehicle systems;
providing alerts through a speaker of a wireless headset in the vehicle based on the information indicating occurrence of trigger events; and
determining when to provide each alert based on a priority level of the alert within a multi-level hierarchy of priority levels.

10. The method of claim 9, comprising:
determining when to provide each alert further based on whether the wireless headset is engaged in a communication session when the alert is triggered.

11. The method of claim 10, comprising:
interrupting the communication session to provide a particular alert based on the particular alert corresponding to a first priority level of the multi-level hierarchy; and
postponing providing the particular alert until after the communication session is complete based on the particular alert corresponding to a second priority level that is below the first priority level in the multi-level hierarchy.

12. The method of claim 11, wherein:
the control circuitry includes a first electronic control unit (ECU) that is part of the wireless headset and also includes a second ECU that is separate from the wireless and is configured to communicate with at least one of the plurality of vehicle systems over a vehicle communication bus; and
the first ECU performs the determining steps, interrupting step, and postponing step.

13. The method of claim 11, wherein:
the control circuitry includes an electronic control unit (ECU) of the vehicle that is separate from the wireless headset;
to provide each alert the ECU transmits the alert or an identifier for the alert to the wireless headset; and
the ECU performs the determining steps, interrupting step, and postponing step.

14. The method of claim 9, wherein the plurality of vehicle systems include at least two of an infotainment system, an electronic logging device system, a driver information system, a vehicle monitoring system, a camera monitor system, a telematics system, and a cabin driver monitoring system.

15. The method of claim 14, wherein said providing alerts comprises:
obtaining driver attentiveness data from one of the vehicle systems or from the wireless headset indicative of a level of attentiveness of a driver of the vehicle;
comparing the driver attentiveness data to predefined criteria for a non-attentive driving trigger event; and
providing a non-attentive notification via the speaker based on the driver-attentiveness data meeting the predefined criteria.

16. The method of claim 15, comprising:
the control circuitry obtaining obtain the driver attentiveness data from a motion sensor of the wireless headset, from the camera monitor system, or from a driver monitoring camera of the cabin driver monitoring system.

17. The method of claim 14, comprising:
recording, by an electronic logging device, drive time data for a driver of the vehicle indicative of an amount of driving time of the driver during a time period;
wherein the electronic logging device is one of the vehicle systems; and
wherein one of the trigger events corresponds to the driving time exceeding a predefined drive time threshold for the time period.

18. The method of claim 14, wherein:
one of the vehicle systems is the vehicle monitoring system which is configured to monitor vehicle data indicative of an operational condition of the vehicle; and
one of the alerts corresponds to the vehicle data crossing a predefined warning threshold.

19. The method of claim 18, wherein the predefined warning threshold is a tire pressure threshold, an engine temperature threshold, or a fuel level threshold.

20. The method of claim 9, comprising:
receiving spoken commands from a microphone of the wireless headset; and
controlling at least one of the vehicle systems or at least one additional vehicle system based on the spoken commands by performing one or more of:
commanding the camera monitor system to adjust how it provides images of an area around the vehicle or to initiate an event recording session;
commanding the infotainment system to adjust input parameters for vehicle navigation, a HVAC system of the vehicle, or stereo of the vehicle;
commanding a cabin lighting system to adjust cabin lighting of the vehicle;
commanding the vehicle telematics system to initiate a phone call; and
commanding the electronic logging device system to authenticate a driver of the vehicle or adjust a duty status of the driver.
